(19) United States
(12) Patent Application Publication
(10) Pub. No.: US 2026/0080360 A1
(43) Pub. Date: Mar. 19, 2026

(54) INDUSTRIAL INVENTORY TRACKING

(71) Applicant: Maanav Iyengar, Naperville, IL (US)

(72) Inventor: Maanav Iyengar, Naperville, IL (US)

(21) Appl. No.: 19/311,567

(22) Filed: Aug. 27, 2025

Related U.S. Application Data
(60) Provisional application No. 63/688,030, filed on Aug. 28, 2024.
(60) Provisional application No. 63/808,164, filed on May 19, 2025.

(51) Int. Cl. G06Q 10/087; B65G 1/137

(52) U.S. Cl. CPC G06Q 10/08772; B65G 1/1373; B65G 2203/0216; B65G 2203/0233; B65G 2203/0258; B65G 2203/041; B65G 2203/044; B65G 2203/048

(57) ABSTRACT

An automation module deployed in static or mobile form around an inventory facility such as a warehouse employs multiple modes of sensors for continuously gathering inventory signals indicative of a location, type and quantity of each of the types of items stored in the inventory facility. An auditing server receives the inventory signals from each of the automation modules around the inventory facility for aggregating and coalescing the inventory signals to eliminate duplicate references and compute a discrete quantity and location of each type of item in the inventory facility. The automation modules may be adhered to a vehicle such as a forklift, installed on the weight-bearing prongs of the forklift, and/or affixed to walls or exit doorways, and each automation module may gather sensor data through video, weight, Lidar, inertial/gyroscopic, GPS (Global Positioning System) and other mediums that may aid in accurate cataloging and auditing of warehouse contents.

### RELATED APPLICATIONS

This patent application claims the benefit under 35 U.S.C. § 119(e) of U.S. Provisional Patent App. No. 63/688,030, filed Aug. 28, 2024, entitled “WAREHOUSE AUTOMATION AND AUDITING,” and U.S. Provisional Patent App. No. 63/808,164, filed May 19, 2025, entitled “INDUSTRIAL INVENTORY TRACKING,” both incorporated herein by reference in entirety.

### BACKGROUND

An active industrial economy relies on an ability to move raw materials, industrial goods and consumer products through the various stages of inception, manufacturing, fabrication, and end user/consumer delivery. Each increment in development and delivery of an article of commerce requires an inventory of items awaiting a successive stage, process or transformation. Whether the articles of commerce are bulk materials, unfinished parts, or a completed product, a controlled stock is needed to ensure that the chain of distribution remains satiated to avoid disruptions and inconsistencies that can lead to starvation and bottlenecks in the distribution chain.

Inventory repositories for normalized, organized storage of items are employed to temporarily store items pending a successive stage, typically awaiting transport by truck, rail or air. Often referred to as warehouses, distribution centers, or stockpiles, a basic expectation is storage, cataloging and efficient retrieval of a known quantity of items of each of a particular type. Strategic locations of multiple warehouses allows a consistent, cyclic flow of needed goods.

### SUMMARY

An automation module deployed in static or mobile form around an inventory facility such as a warehouse employs multiple modes of sensors for continuously gathering inventory signals indicative of a location, type and quantity of each of the types of items stored in the inventory facility. An auditing server receives the inventory signals from each of the automation modules around the inventory facility for aggregating and coalescing the inventory signals to eliminate duplicate references and compute a discrete quantity and location of each type of item in the inventory facility. The automation modules may be adhered to a vehicle such as a forklift, installed on the weight-bearing prongs of the forklift, and/or affixed to walls or exit doorways, and each automation module may gather sensor data through video, weight, LIDAR (Light Detection and Ranging), inertial/gyroscopic, GPS (Global Positioning System) and other mediums that may aid in accurate cataloging and auditing of warehouse contents. A digital twin of the inventory facility is generated for visual and augmented reality (AR) rendering of the cataloged and audited inventory quantity, type and location.

Configurations herein are based, in part, on the observation that warehouses contain various quantities of a large variety of different commodity items. Unfortunately, conventional approaches to warehouse management suffer from the shortcoming that the overall mass and quantity, combined with overhead incurred in accurately tracking the type, quantity and location of warehouse stored items, is problematic to maintain. Accordingly, improperly cataloged, located, or typed items contribute to loss and “shrinkage” of stock utilization. Accordingly, configurations herein substantially overcome the shortcomings of conventional inventory management and auditing by providing a method for monitoring, tracking and coalescing stock in an inventory facility by deploying a plurality of automation modules around the inventory facility for continual updating and maintaining an inventory database, coupled with a “digital twin” that electronically represents the stored items and physical configuration in a form suitable for augmented reality (AR) rendering. By affixing the automation module to vehicles such as forklifts, carts and other transports, and thereby transporting each of the automation modules around the inventory facility, a continually updating database and digital twin model of the inventory facility may be maintained. The digital twin supports a photorealistic, visual representation of the warehouse for applications operable for virtual reality (VR), augmented reality (AR) and database aggregation and analytics.

In operation, as the plurality of automation modules traverses the inventory facility, each transmits an inventory signal to an auditing server. The auditing server coalesces the inventory signals for identifying at least an item type, an item count and an item location within the inventory facility. The inventory signals comprise multi-modal information from a variety of sensors, such as video, weight, LIDAR and others.

For inventory signals defining a video image of one or more items in the inventory facility, the auditing server aggregates a plurality of the video images for computing a quantity of items of a particular type of item in the inventory facility. When aggregating a plurality of sequential inventory signals for computing a quantity of a common item type, it is important to distinguish individual items represented in each signal or frame of video information to ensure each item is “counted” only once, as each item may be represented in a plurality of the inventory signals, i.e. included in multiple frames as the moving automation module pans across a stock of items.

Other automation modules may reside on a fork or load bearing member of a forklift or transport. In this instance, the inventory signals may include a weight representative of an atomic unit, such as a palate, of one or more items in the inventory facility. As a forklift places a pallet, for example, a weight of the pallet along with a visual of the items along a side of the palate may help ascertain a total number of items on a loaded pallet, as a visual from a single perspective can be difficult to derive depth. The multi-modal (multiple sensor types) therefore helps to compute quantity even when some items remain “hidden” behind others due to a depth of items stored.

In further detail, in an inventory facility for storing items in conjunction with commercial transport, each item having an identity and placement at a location within the inventory facility, the disclosed approach implements a method for gathering and mapping warehouse inventory by receiving an optical signal indicative of an identity and placement of an item within an inventory facility, and stores the identity and the placement of the item in the inventory repository. Subsequently, an auditing server retrieves the placement from the inventory repository in response to a request matching the identity of the item, and renders the identity and location of the item based on the retrieval.

### BRIEF DESCRIPTION OF THE DRAWINGS

The foregoing and other features will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles of the invention.

FIG. 1 is a context diagram of an industrial warehouse environment suitable for use with configurations herein;

FIG. 2 is a perspective view of an inventory tracking device engaged with an inventory management vehicle in the environment of FIG. 1;

FIG. 3 is a schematic view of the warehouse automation and auditing system for tracking inventory in the environment of FIG. 1;

FIGS. 4A-4C show a GUI (Graphical User Interface) rendering of an item picking operation using the device of FIG. 2 in the environment of FIG. 1;

FIGS. 5A-5B show GUI renderings of individual commodity item recognition using the device of FIG. 2;

FIGS. 6A-6B show GUI renderings of a management screen for evaluating inventory in the environment of FIG. 1; and

FIGS. 7A-7B are a process flow of item intake and monitoring into the inventory of the environment of FIG. 1.

### DETAILED DESCRIPTION

Configurations described below depict the automation module as a self contained monitoring device including sensors (cameras, inertial and weight), electronic circuitry, processors, memory and a battery power supply capable of motorized or ambulatory traversal around a warehouse environment defining the inventory facility. A particular invocation attaches the monitoring device to a forklift vehicle in view of the load, however hand carry and even stationary placement may also be employed.

A typical inventory facility includes a warehouse floor area defined by a planar floor surface, usually a flat concrete slab, and elevated racks spaced in rows at regular intervals extending from the floor surface, such that each of the elevated racks is configured for storage of inventory items. Many vehicles, such as forklifts and platform transports, may traverse the floor area for storing and retrieving items (goods). Multiple automation modules are adhered or affixed to these vehicles configured for traversing the inventory facility, thereby disposing each respective automation module in a continual, transient proximity with the items in the inventory facility.

A particular improvement provides continuous or real time item tracking during the entire warehouse tenure, from intake via truck/forklift/handcarry until reloading for outgoing shipment. The continuous tracking approach mitigates errors and redundancy because discrepancies may be detected immediately on intake, and again during picking for outgoing transit. In contrast to conventional approaches which validate picked shipments only upon aggregation of an entire picked order, the real time correlation catches discrepancies at the point of picking/gathering the stock for shipment.

From the continually updated inventory signals, the auditing server computes a quantity of a particular item type in the inventory facility and determines, based on the inventory signals, a location of each of the items in the inventory facility, either by pallet, row and height, or individual item. Using this information, the auditing server constructs a digital twin indicative of a location and quantity of each of the plurality of items in the inventory facility. The digital twin can be responsive to query requests and visual requests for rendering a location, item type and quantity in the inventory facility, such as by AR rendering mechanisms.

As indicated above, a particular configuration deploys a plurality of monitoring devices defining the inventory automation modules around the inventory facility, where each automation module includes an input sensor configured to detect each of a plurality of items in an inventory facility, and a communications interface in wireless communication with an auditing server. The auditing server occupies a central location and includes memory and logic for coalescing the plurality of items. Continual or real time exchanges allow the auditing server to maintain current inventory data. The automation module may be deployed around the inventory facility in a stationary or mobile manner using an attachment means for affixing the automation module to a vehicle traversing the inventory facility. The communication interface is in communication with the auditing server and a local memory on the automation module, such that the item data may include descriptive, image, and animated renderings of the item data.

Each automation module typically includes a plurality of input sensors for gathering the inventory data, through one or more of a video camera, LIDAR, IMU (Inertial Measurement Unit) and GPS (Global Positioning System). The communications interface, such as a Bluetooth or WiFi transmitter, is configured to transmit an indication of a location and quantity of an item in the inventory facility for maintaining an accurate quantity and location of the items, without duplicity from multiple automation modules detecting the same item. This continual, non-duplicative auditing results from a plurality of automation modules deployed in the inventory facility, such that the communications interface allows the auditing server to coalesce and distinguish an item detected by multiple of the plurality of automation modules. The automation module also has memory and processing capability for cached and local coalescing and processing of the item data.

The input sensor is configured to identify an item of the plurality of items during an intake into the inventory facility, such that the same item may be tracked upon arrival, while the communications interface is configured to correlate successive detections of the item for inventory calculations with non-duplicative item counts. Images, position and other features of an item may be transmitted and coalesced with previous gathered data in an absence of a formatted symbol such as a bar code or similar pattern. Only visual features, location, and movement data (such as when an order is picked) are employed for maintaining unitary counts of each item, thus avoiding multiple counts of the same item.

As the inventory facility receives and stores items in various containment forms, the automation module and auditing server are configured to detect an item in a form of at least one of a single item, box of a plurality of items, and pallet of items. The communications interface is therefore configured to continually update a digital twin indicative of, for each item in the inventory facility, a location and a quantity of like items during a tenure in the inventory facility. The digital twin is typically expected to be a data structure which is continually updated for identifying the location and count of each item from intake, through storage and order picking until departure/shipping, based on a collective stream of data from each of the automation modules.

The automation module further includes, or has access to, a memory for storing the digital twin responsive to virtual reality (VR) access from a corresponding application. The automation module may employ an interface to the application for maintaining a VR user experience using the digital twin. It should be further noted that the memory storage for the item data and digital twin may be either centrally located and/or distributed among the automation modules. In other words, sufficient memory may enable a mirrored rendering of the complete item data and digital twin on each automation module, and/or a caching and updating approach may effectively distribute the relevant information as needed to individual automation modules, while retaining a master or complete set at the auditing server. It will be apparent that the level of caching and updating is based on the size of the inventory facility and a quantity of tracked items therein.

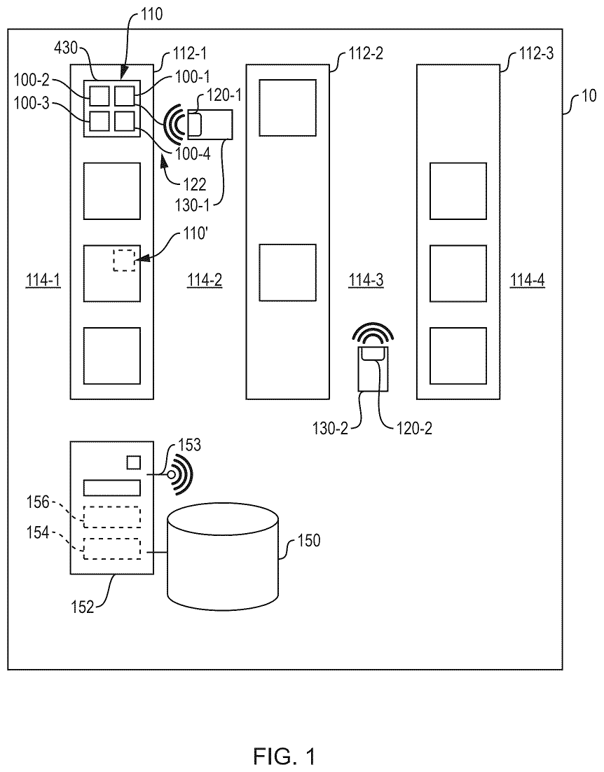

FIG. 1 is a context diagram of an industrial warehouse environment suitable for use with configurations herein. In an inventory facility 10 for storing items 100-1 . . . 100-N (100 generally) in conjunction with commercial transport, each item 100 has an identity and placement at a location 110 within the inventory facility 10. A mobile automation module 120 provides a method for gathering and mapping the inventory of the warehouse, by receiving an optical signal 122 indicative of an identity and placement of each item 100 within the inventory facility 10. The automation module 120 may be attached or secured to a retrieval vehicle 130-1 . . . 130-2 (130 generally) such as a forklift or motorized cart, and stores the identity and the placement of the item 100 in an inventory repository, typically a database 150, cloud storage, or other suitable storage medium responsive to an auditing server 152.

Each inventory automation module 120 includes one or more input sensors configured to detect each of the plurality of items 100 in the inventory facility 10. In an example configuration, the input sensor includes one or more of a video camera, LIDAR, IMU (Inertial Measurement Unit) and GPS. Optical sensors such as a stereo RGB camera and LIDAR provide much of the relevant information for identifying and tracking the items 100 in the facility 10. Each automation module 120 also includes a communications interface in wireless communication with the auditing server 152, which has a memory 154 and logic 156 for coalescing the plurality of items, discussed further below. For mobile deployment, an attachment means such as a strap or magnet is used for affixing the automation module 120 to the retrieval vehicle 130 traversing the inventory facility.

While GPS may be employed for defining locations within the facility 10, optical signals and derived position information allows mapping and directing the automation modules 120 around the facility 10 for matching items 100 for fulfilling storage and retrieval requests.

Each item 100 in the facility 10 has a placement defined by the location 110 and an identity of each respective item 100. Placement may change as the item (defined by the identity) is transferred to a different location 110′ or out of the facility 10 for subsequent transport. The identity of each item may be a warehouse identifier and/or established by optical features of the item, discussed further below. Location 110 is typically in terms of rows of shelves 112-1 . . . 112-3 (112 generally) of storage bays 1 . . . 114-N (114 generally), and having multiple levels 116 for storage. Any suitable location arrangement may be employed, however. It is expected that the retrieval vehicle 130 is operable for accessing any location 110 for intake or retrieval of an item, but locations 110 may also be mapped to vehicles capable of access.

Upon a request for item transport, the auditing server 152 retrieves the placement from the database in response to a request matching the identity of the item 100. This allows deployment of a transport vehicle to the location 110 of the item 100 for retrieving the item based on the retrieved placement information. Through a control GUI (Graphical user interface), the auditing server 152 renders the identity and location of the item based on the retrieval to allow the retrieval vehicle 130 to travel to the location 100 seeking the item 100 matching the identity.

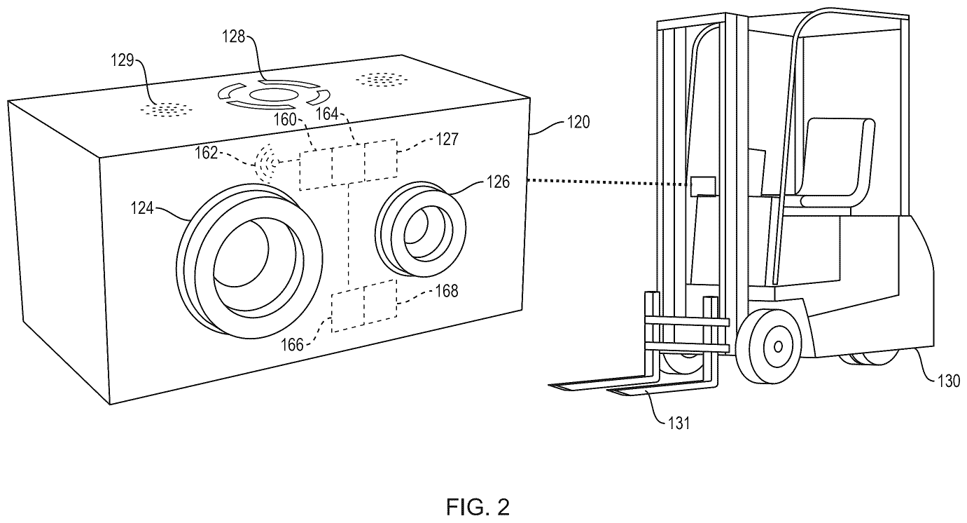

FIG. 2 is a perspective view of the automation module 120 defining an inventory tracking device engaged with an inventory management vehicle or retrieval vehicle 130 in the environment of FIG. 1. Referring to FIGS. 1 and 2, the database 150 is continually updated by transporting a monitoring device such as the automation module 120 around the inventory facility 10 while attached to the retrieval vehicle 130. The automation module 120 includes one or more sensors for gathering the optical signal, such as a stereo RGB camera 124 or other imaging medium, a LIDAR/TOF (time of flight) sensor 126, interface 127 to a weight sensor for the lift fork 131, as well as output peripherals such as a visual warning light 128 and audible alarm 129 for warning of an imminent situation (e.g. collision with another vehicle or worker).

The automation module 120 also includes a processor 160 for receiving the optical signals, a wireless transmitter 162 (e. g Bluetooth® or WiFi®) for transmitting the optical signals to an antenna 153 at the auditing server 152 for determining the identity and placement of the item. A memory 164 stores instruction and data for the processor 160, and optionally for onboard computing of the identity and placement of the item for transmission to the auditing server 152. A power supply 166 such as a battery connects to the one or more sensors 124, 126, 127, the processor 160 and the wireless transmitter 162.

Maintaining the inventory further includes affixing the automation module 120 device to the retrieval vehicle 130, and transporting the vehicle 130 around the inventory facility 10 in an adjacency with each item of the plurality of items for receiving the optical signals 122 indicative of each of the items 100.

Optical sensors (cameras) 124, 126 are depicted as one sensory medium for identifying placement of an item 100, however any suitable sensor or combination of sensor input may be employed. As indicated above, an item handling member such as the fork 131 may be integrated into to the vehicle, and weight sensors attached to the item handling member, such that the weight sensors are in communication with the automation module 120 via the interface 127. This allows the automation module to receive signals indicative of a weight of the item 100 or items, and to store the weight along with the placement of the item 100 in the inventory repository database 150. Inertial sensors 168, such as accelerometers, combine with the image data to detect position changes of the retrieval vehicle and raising/lowering of the lift fork 131.

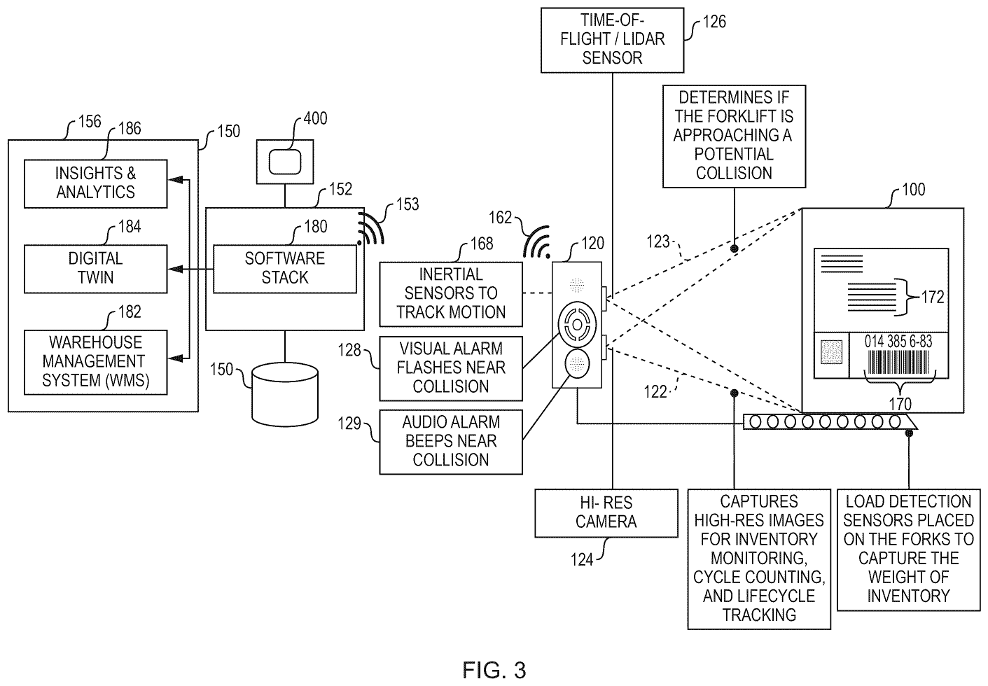

FIG. 3 is a schematic view of the warehouse automation and auditing system for tracking inventory in the environment of FIG. 1. Referring to FIGS. 1-3, the automation module 120 receives an optical signal 122 including an image of the item 100. Concurrently, the LIDAR/Time-of-Flight sensor receives a depth signal 123 indicative of a distance or depth of an object, which serves a dual purpose of determining a distance or depth of an approached/scanned item, and also collision avoidance of other fixtures and vehicles in the inventory facility 10.

Often, items 100 arriving and stored include an image of a coded symbol 170 having a predetermined pattern of symbols denoting an alphanumeric sequence. This pattern of symbols is most commonly a series of linear segments or a two dimensional square segments defining a UPC (Universal Product Code) symbol or QR (Quick Response) code, however other symbol patterns may be employed. Additionally or in the alternative, any text labels 172 on the item as well as size, color and surroundings, such as warehouse shelf or bay markings may also be recorded.

The wireless transmitter 162 transmits the received signals 122, 123 to a receiving antenna 153 at the auditing server 152 (“transmitter” as employed herein is intended to depict bidirectional transmit/receive communication capability). The auditing server 152 includes a software stack 180 defining program code instructions for managing the database 150 and item 100 tracking as defined herein. The software stack 180 includes the logic 156 for managing and coalescing the gathered item 100 data, accessible from the GUI 400 (discussed further below). A warehouse management system 182 maintains the location 110 and scanned information from received signals 122 for each item 100. A digital twin 184 provides a visual or augmented reality version of the facility 10 layout and items 100 within, disposed in the corresponding location 110. Insights and analytics allows feature matching and identity determination of the scanned items to ensure each item 100 is recorded only once during movement through the facility 10. Reports and summary information is obtained from an insights and analytics application 186.

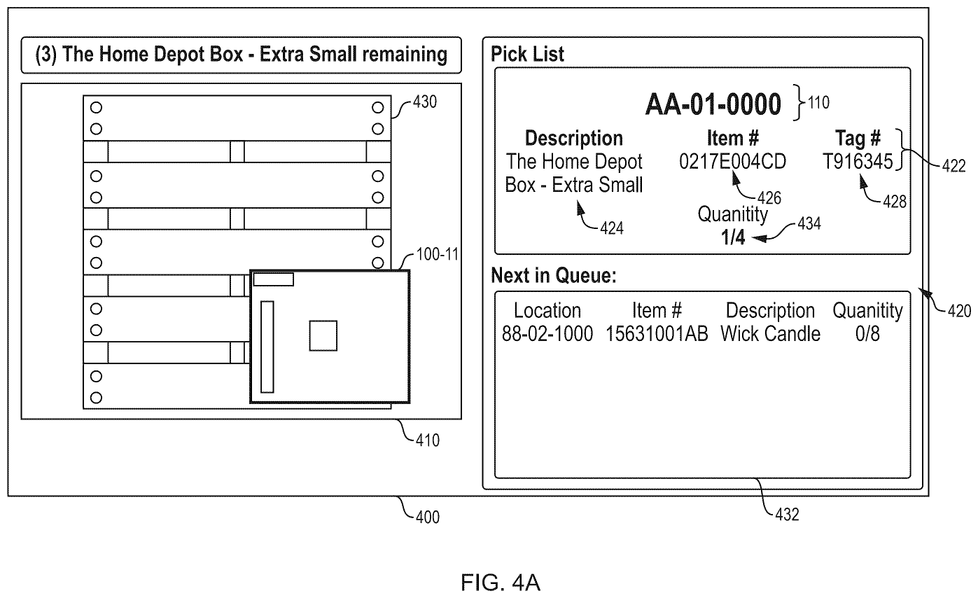

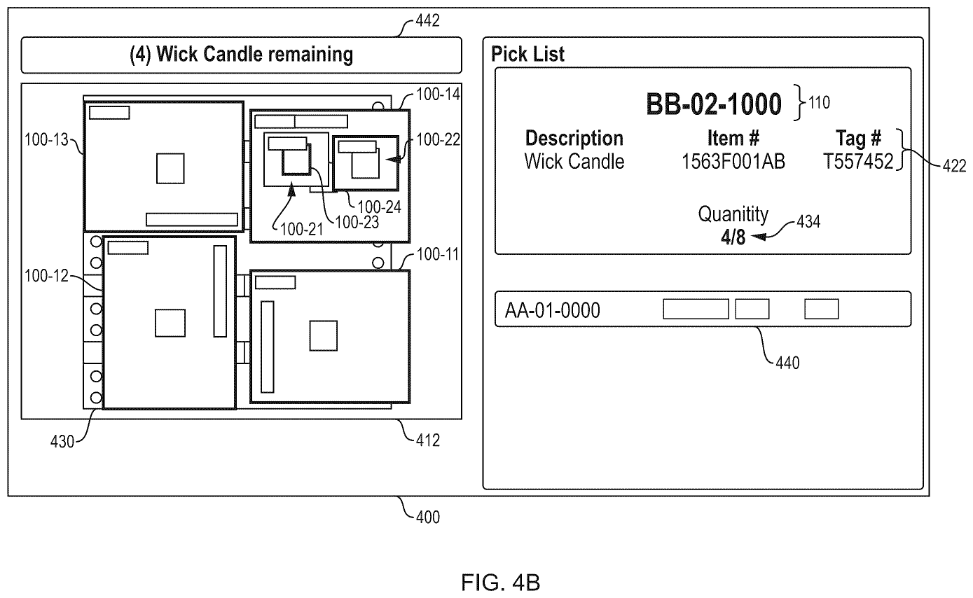

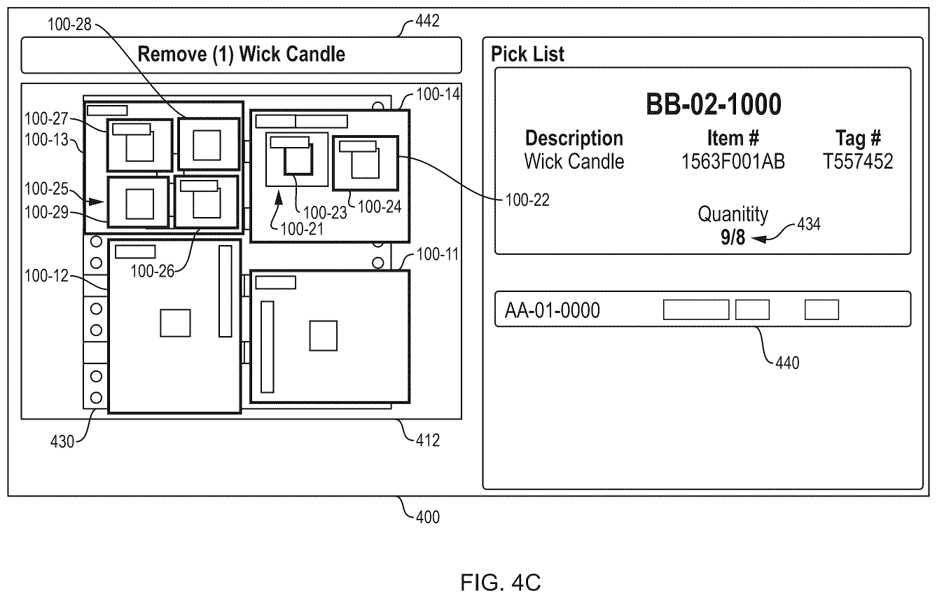

FIGS. 4A-4C show the GUI (Graphical User Interface) 400 rendering of an item picking operation using the device of FIG. 2 in the environment of FIG. 1. A user or operator interacts the GUI 400 via a suitable visual display screen interface with a keyboard/mouse or other suitable input/output capabilities.

The auditing server 152 receives the optical signals 122 indicative of a shape, size and depth of the item, with or without a coded symbol. It also receives optical signals indicative of surroundings around the item, such as a shelf or bay label, and other features such as adjacent items and context visuals of the facility 10. Using the received signals, the server 152 matches the shape, size, depth and surroundings of the item with the database 150 model for mapping to an identity if the item, and stores or confirms the identity and the location 110 of the item as a placement of the item.

Commencing with FIG. 4A, for the located item 100 the GUI 400 renders an image 410 of the current placement of the item in an identity features window 420. A multitude of warehouse inventory operations may be achieved with various screens of the GUI 400. For an outgoing order pick operation, a plurality of items 100 are loaded onto a palate 430, visualized from the received optical signals 122. The image 410 is shown as an overhead or plan view, while a perspective from the retrieval vehicle 130 might yield a perspective view from a downward angle. For the pick operation, renderable features 422 of the item 100 are displayed, including a textual description 424 based on scanned text, a unique item ID 426 assigned by the auditing server 152 for each item, and a tag number 428 referring to a pick request, customer order or similar field regarding the pick operation. The location 110 shows the location where the item 100-11 was picked from prior to placement on the palate 430. For the pick operation, a next in queue window 432 shows the location of the next item 100 for retrieval, and a count 434 shows the number of items remaining in the current pick operation, showing 3 additional items to fulfill the quantity of 4 HOME DEPOT® boxes requested by the pick operation as items 100-11 . . . 100-14.

In FIG. 4B, proceeding to the next item pick request, a window 412 shows the current pallet 430 accumulation of items 100-11 . . . 100-14 while gathering the next item—a quantity of 8 wick candles, of which items 100-21-100-24 have been placed on the pallet 430. It should be noted that the items 100-23 and 100-24 are stacked on items 100-21 and 100-22, shown by arrows pointing to the items concealed under others. The previous, completed pick of items 100-1 . . . 100-4 is shown in status window 440, while a current step of the pick operation is shown in step window 442. Proceeding to FIG. 4C, pick items 100-25 . . . 100-28 are stacked on top of item 100-13 to complete the requested 8 wick candles. However, an extra item 100-29 is stacked on top of item 100-25. Accordingly, having detected an excess of 9 items to the requested 8, the step window 442 notes a removal of item 100-29.

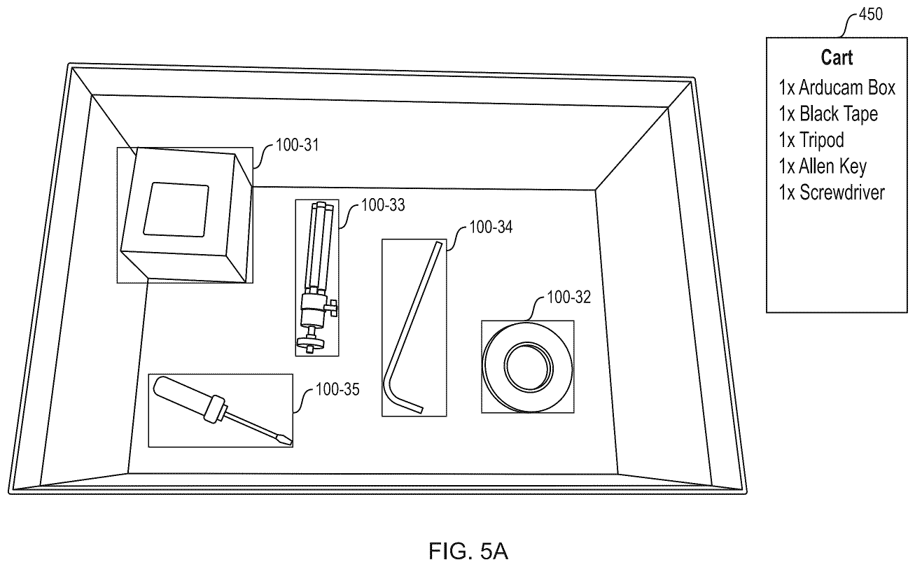

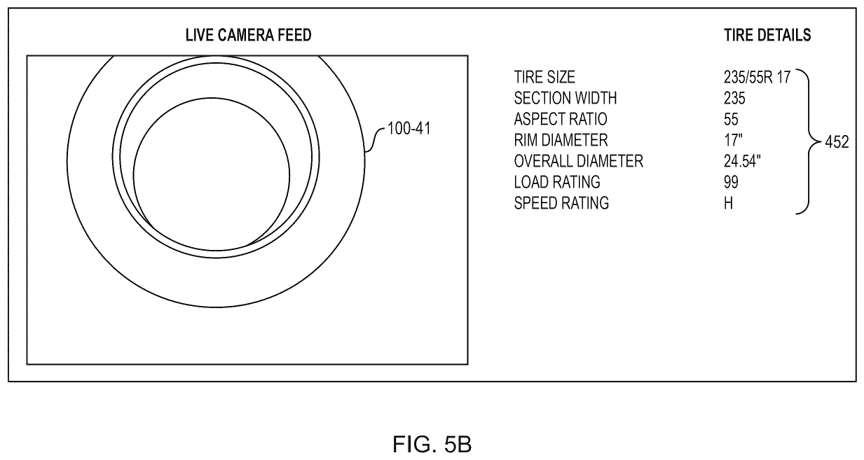

FIGS. 5A-5B show GUI renderings of individual commodity item recognition using the device of FIG. 2. In FIG. 5A, while a typical pick operation is denoted by loading loaded boxes onto a pallet 430, a more granular recognition of items 100 in a box is achievable, again with or without coded symbols 170 among the recognized visual features. Identified items 100-31 . . . 100-35, outlined by green boxes indicating a recognized item, are shown in cart window 450.

Referring to FIG. 5B, indicia from a bulk item are recognized from visual features of the item 100-41, and shown in item detail 452.

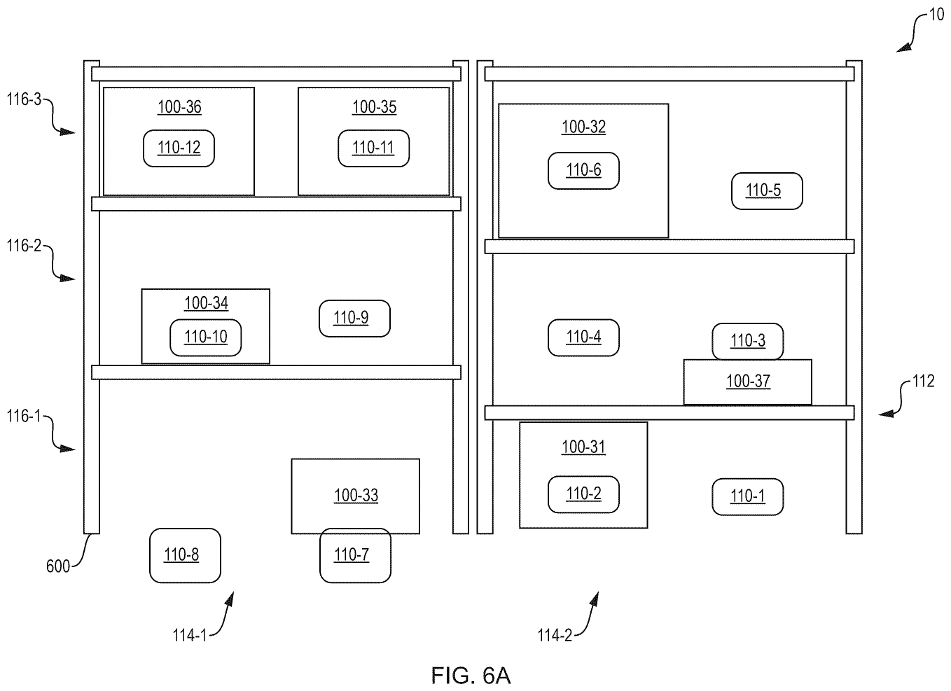

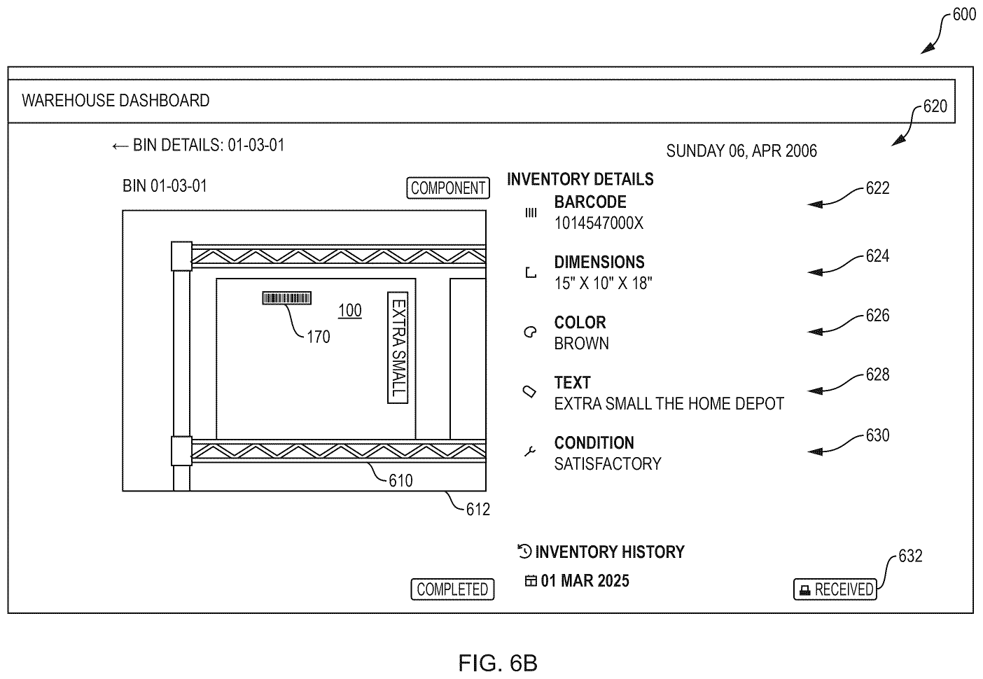

FIGS. 6A-6B show GUI renderings of a management screen for evaluating inventory in the environment of FIG. 1. Referring to FIG. 6A, a GUI screen 600 depicts an elevation view of storage locations 110-1 . . . 110-12. The inventory facility 10 typically includes rows of the shelves 112, having bays 114-1 . . . 114-2, which store items on vertically arranged levels 116-1 . . . 116-3 in a stack for forklift access. Each row of shelves 112 and levels 116 denotes locations 110-1 . . . 110-12, which may or may not be occupied by items 100-31 . . . 100-37. An item 100-N stored in a location 110 defines the placement of the item 100, while vacant locations 110-1, 4, 5, 8 and 9 are available for placement of incoming or moved items 100.

FIG. 6B shows an item detail screen 600 for a single item 100 from the GUI of FIG. 6A. An image window 612 renders an image of the item 100 on a wireframe shelf denoted by location 110 identifier 610. An inventory details window 620 includes a barcode window 622 rendering the corresponding coded symbol 170. Alternatively, even if a barcode was not scanned, the barcode may have been previously scanned from another package side, and identified from other features, such as the location identifier 610, dimensions 624, color 626, textual descriptions 628 on the box, and/or condition 630. The same item 100 may be scanned multiple times as a plurality of the automation modules 120-N iteratively scan items 100 during passage through the inventory facility 10. An identity is gathered from available features, of which a coded symbol is one of several features which may be used to identify each individual item 100-N. The unique item ID 426 is assigned upon an initial scan, and the corresponding location iteratively refreshed during successive iterations, for example if an item is manually moved around the facility 10.

Item queries may also be received verbally, such as through a text to speech utility and/or an LLM (Large Language Model) in addition to keyboard entry. Spoken recognition include receiving audio signals indicative of at least one of a shape, size, depth, placement or coded symbol, such as a barcoded string of digits. Also received is a command for directing an action performable on the item, such as for status, move or export from the facility. The auditing server 152 maps the received audio signals to an item placement in the facility, meaning a matching item 100 and the location 110 where it resides, and performs the directed action, such as rendering the item details or deploying a retrieval vehicle 130 to the location 110.

The database 150 storing the item details may be queried or accessed by any suitable approach for retrieving and/or updating information on the items 100 cataloged in the facility. A coded symbol identifier, item ID 426, or any of the scanned features from the optical signals 122 may be employed. The information may be stored by a relational form with typed field, unstructured data in in a script form, or a machine learning (ML) model trained on the aforementioned features applicable to each item. In a general depiction of an ML model, the auditing server 152 receives optical signals indicative of a coded symbol affixed on the item, and matching the coded symbol with the model for mapping to an identity if the item. Various other features in addition to a deterministic coded symbol may also be employed as described above.

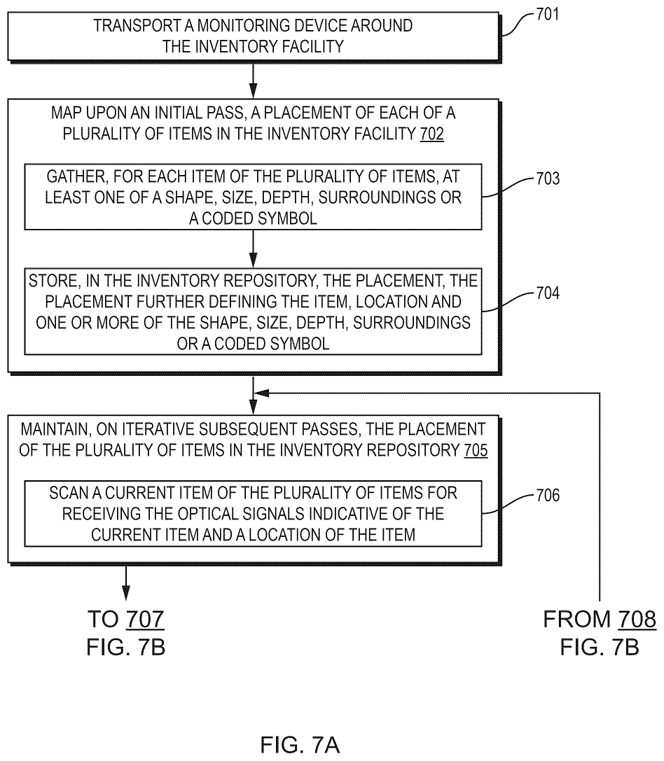

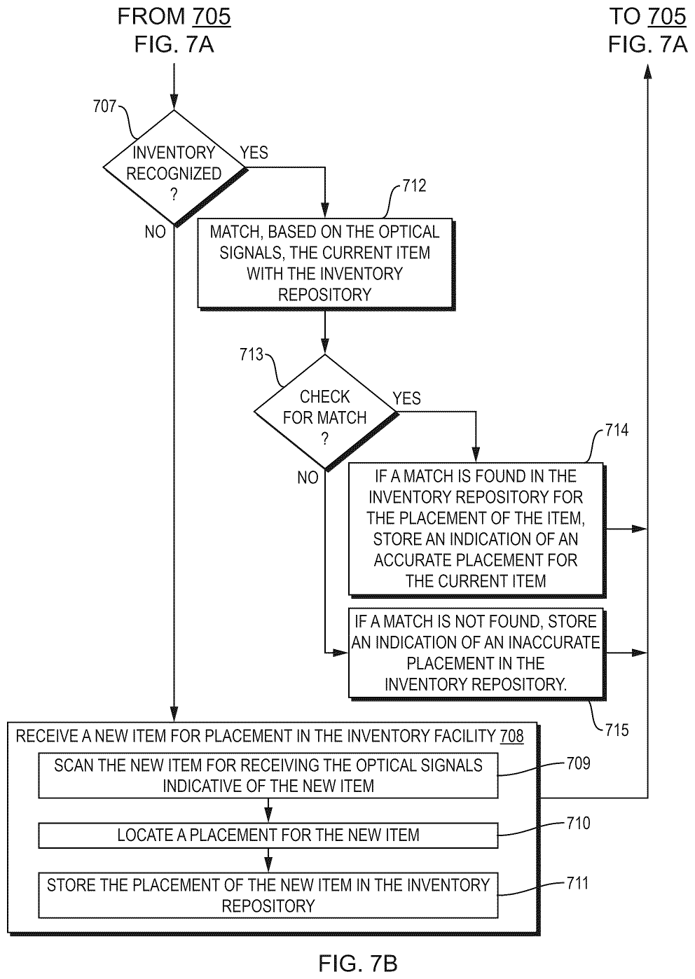

FIGS. 7A-7B are a process flow 700 of item intake and monitoring into the inventory of the environment of FIG. 1. Initialization commences with an initial recognition and cataloging of each item already in the inventory facility 10, followed by maintaining and recognizing new arrivals to inventory. An archivable history can maintain item handling until departure. Referring to FIGS. 1-7B, at step 701 a retrieval vehicle 130, ambulatory worker or other means transports the automation module 120 or monitoring device around the inventory facility 10. The automation module 120 maps, upon an initial pass, a placement of each of a plurality of items in the inventory facility, as disclosed at step 702. This includes gathering, for each item of the plurality of items, at least one of a shape, size, depth, surroundings or a coded symbol, as shown at step 703, and storing the placement in the database 150, such that the placement further defines the item, location and one or more of the shape, size, depth, surroundings or a coded symbol, as depicted at step 704.

Any suitable number of automation modules 120-N may be scaled to the inventory facility, each collaborating with the auditing server.152 for maintaining the inventory. Following initial inventory repository database 150 population, the auditing server 152 maintains, on iterative subsequent passes, the placement of the plurality of items 100 in the inventory facility 10, as shown at step 705. Thus, as the automation modules 120 move around the facility, scanning is performed of a current item 100′ of the plurality of items for receiving the optical signals indicative of the current item and a location of the item, as depicted at step 706. The most typical scenario is that an automation module 120 is secured to each retrieval vehicle 130 for scanning and reporting item placement during facility 10 traversal.

During the iterative scan, a check is performed, at step 707, to determine if the inventory is recognized by the auditing server 152. If the item 100 is not recognized, then the auditing server receives the new item 100 for placement in the inventory facility 10, as disclosed at step 708. This includes scanning the new item 100 for receiving the optical signals 122 indicative of the new item 100, as depicted at step 709, and locating a placement for the new item 100 by identifying a vacant location 110, as shown at step 710. The auditing server then deploys a retrieval vehicle 130 or other mechanism to establish the placement of the new item in the inventory repository database 150, as depicted at step 711.

If the inventory is recognized in the check at step 707, then the auditing server 152 seeks a match, based on the optical signals 122, the current item 100 with the inventory repository database 150, as disclosed at step 712. A check is performed at step 713, and if a match is found in the inventory repository database 150 for the placement of the item, the auditing server storing an indication of an accurate placement for the current item, as depicted at step 714. In contrast, if a match is not found, meaning a misplaced or unentered item 100, the auditing server 152 stores an indication of an inaccurate placement in the inventory repository database 150, as depicted at step 715. Remedial measures such as manual tracking and/or repositioning may then be performed to rectify.

Those skilled in the art should readily appreciate that the programs and methods defined herein are deliverable to a user processing and rendering device in many forms, including but not limited to a) information permanently stored on non-writeable storage media such as ROM devices, b) information alterably stored on writeable non-transitory storage media such as solid state drives (SSDs) and media, flash drives, floppy disks, magnetic tapes, CDs, RAM devices, and other magnetic and optical media, or c) information conveyed to a computer through communication media, as in an electronic network such as the Internet or telephone modem lines. The operations and methods may be implemented in a software executable object or as a set of encoded instructions for execution by a processor responsive to the instructions, including virtual machines and hypervisor controlled execution environments. Alternatively, the operations and methods disclosed herein may be embodied in whole or in part using hardware components, such as Application Specific Integrated Circuits (ASICs), Field Programmable Gate Arrays (FPGAs), state machines, controllers or other hardware components or devices, or a combination of hardware, software, and firmware components.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. In an inventory facility for storing items in conjunction with commercial transport, each item having an identity and placement at a location within the inventory facility, a method for gathering and mapping warehouse inventory, comprising:
receiving an optical signal indicative of an identity and placement of an item within an inventory facility;
storing the identity and the placement of the item in the inventory repository; and
retrieving the placement from the inventory repository in response to a request matching the identity of the item; and
rendering the identity and location of the item based on the retrieval.

2. The method of claim 1 further comprising retrieving the item by:
deploying a transport vehicle to the location of the item; and
retrieving the item based on the retrieved placement.

3. The method of claim 1 further comprising receiving an optical signal including an image of a coded symbol, the coded symbol having a predetermined pattern of symbols denoting an alphanumeric sequence.

4. The method of claim 3 wherein the pattern of symbols is a series of linear segments or a two dimensional square segments defining a UPC symbol or QR code.

5. The method of claim 1 further comprising:
transporting a monitoring device around the inventory facility, the monitoring device including:
one or more sensors for gathering the optical signal;
a processor for determining the identity and placement of the item;
a wireless transmitter for transmitting l to an auditing server; and
a power supply connected to the one or more sensors, the processor and the wireless transmitter.

6. The method of claim 1 further comprising:
transporting a monitoring device around the inventory facility, the monitoring device including:
one or more sensors for gathering the optical signal;
a processor for receiving the optical signals;
a wireless transmitter for transmitting the optical signals to an auditing server for determining the identity and placement of the item; and
a power supply connected to the one or more sensors, the processor and the wireless transmitter.

7. The method of claim 1 further comprising:
receiving optical signals indicative of a shape, size and depth of the item;
receiving optical signals indicative of surroundings around the item matching the shape, size, depth and surroundings of the item with a model for mapping to an identity if the item; and
storing the identity and the location of the item as a placement of the item.

8. The method of claim 7 further comprising
receiving optical signals indicative of a coded symbol affixed on the item; and
matching the coded symbol with the model for mapping to an identity if the item.

9. The method of claim 7 further comprising:
receiving audio signals indicative of at least one of a shape, size, depth, placement or coded symbol;
receiving a command for directing an action performable on the item;
mapping the received audio signals to an item placement; and
performing the directed action.

10. The method of claim 5 further comprising
mapping, upon an initial pass, a placement of each of a plurality of items in the inventory facility;
gathering, for each item of the plurality of items, at least one of a shape, size, depth, surroundings or a coded symbol;
storing, in the inventory repository, the placement, the placement further defining the item, location and one or more of the shape, size, depth, surroundings or a coded symbol.

11. The method of claim 10 further comprising:
maintaining, on iterative subsequent passes, the placement of the plurality of items in the inventory repository, further comprising:
scanning a current item of the plurality of items for receiving the optical signals indicative of the current item and a location of the item;
matching, based on the optical signals, the current item with the inventory repository, and if a match is found in the inventory repository for the placement of the item, storing an indication of an accurate placement for the current item, or
if a match is not found, storing an indication of an inaccurate placement in the inventory repository.

12. The method of claim 11 further comprising:
receiving a new item for placement in the inventory facility;
scanning the new item for receiving the optical signals indicative of the new item;
locating a placement for the new item; and
storing the placement of the new item in the inventory repository.

13. The method of claim 5 further comprising:
affixing the device to a vehicle, and
transporting the vehicle around the inventory facility in an adjacency with each item of the plurality of items for receiving the optical signals.

14. The method of claim 6 further comprising:
integrating an item handling member to the vehicle
attaching weight sensors to the item handling member, the weight sensors in communication with the monitoring device;
receiving signals indicative of a weight of the item; and
storing the weight along with the placement of the item in the inventory repository.

15. The method of claim 9 further comprising:
receiving an audio signal indicative of a command; and
Invoking a LLM (large language model) interface for computing the command.

16. An inventory automation module device, comprising:
an input sensor configured to detect each of a plurality of items in an inventory facility;
a communications interface in wireless communication with an auditing server, the auditing server having a memory and logic for coalescing the plurality of items; and
an attachment means for affixing the automation module to a vehicle traversing the inventory facility.

17. The device of claim 16 wherein the input sensor includes one or more of a video camera, LIDAR (Light Detection and Ranging), time-of-flight (TOF) sensor, IMU (Inertial Measurement Unit) and GPS.

18. The device of claim 16 wherein the communications interface is configured to transmit an indication of a location and quantity of an item in the inventory facility.

19. The device of claim 18 further comprising a plurality of automation modules deployed in the inventory facility, the communications interface configured to coalesce an item detected by multiple of the plurality of automation.

20. A computer program embodying program code on a non-transitory computer readable storage medium that, when executed by a processor, performs steps for implementing a method of gathering and mapping warehouse inventory in an inventory facility for storing items in conjunction with commercial transport, each item having an identity and placement at a location within the inventory facility, the method comprising:
receiving an optical signal indicative of an identity and placement of an item within an inventory facility;
storing the identity and the placement of the item in the inventory repository; and
retrieving the placement from the inventory repository in response to a request matching the identity of the item; and
rendering the identity and location of the item based on the retrieval.
